(19) United States
(12) Patent Application Publication
(10) Pub. No.: US 2008/0174929 A1
(43) Pub. Date: Jul. 24, 2008

(54) Light emitting diode driver

(75) Inventors: Yuh-Ren Shen, Hsinchu (TW); Hung-Chi Chu, Hsinchu (TW)

Correspondence Address: BACON & THOMAS, PLLC, 625 SLATERS LANE, FOURTH FLOOR, ALEXANDRIA, VA, 22314, US

(73) Assignee: VastView Technology Inc., Hsinchu (TW)

(21) Appl. No.: 11/656,987

(22) Filed: Jan. 24, 2007

(51) Int. Cl. H05B 41/36; H02H 3/06; H02H 5/04

(52) U.S. Cl. 361/103; 315/307; 361/93.1

(57) ABSTRACT

A driving system used for light emitting diodes relating to a controllable driver which can detect the voltage desire from application and adjust driving voltage (Vₐₚₚ₁-Vₐₚₚ₂) automatically in order to reach a steady driving current. Additionally, users can adjust the setting of driving current and the output value of DC voltage source for application with different voltage and current requirements through a control interface. The over-temperature and over-current protections (e.g. cutting off driving current or setting the upper limit of driving current) are also included in the system for prevention of possible harms. In the system, a driving system is also disclosed for integration of all the mentioned functions but no need of massive space and can be used in LED lighting system or LED backlight system for constant power emitting.

### BACKGROUND OF THE INVENTION

1. Field of the Invention

This invention generally relates to a light emitting diode (LED) driver, and more specifically relates to a driving control technology of auto voltage adjustment for keeping steady driving current. The present invention is operable to drive high power LEDs (e.g. lighting LED and backlight LED).

2. Description of the Prior Art

In traditionally industrial producing, there are two methods for a constant current driver: one is constant-voltage method to clamp driving current by regulating a setting voltage; the other is constant-current method to clamp driving current by regulating a current source. As the constant-voltage method shown in FIG. 2A (appliance example in this figure is LED), an LED controller 210 regulates an external voltage V_{DD} to an output voltage V_{LED} in order to drive a current I_{LED} on the LED, and further sets a voltage drop Vₛₑₜ cross a resister R connected with the LED in series as well as clamps current on the resister R (also I_{LED} on the LED). As the constant-current method shown in FIG. 2B, an external driving voltage V_{LED} directly applies on an LED to generate a driving current I_{LED}, and an LED controller regulates a reference current by applying an external voltage V_{DD} on a setting resister Rₛₑₜ as well as clamps current I_{LED} on the LED. However, for some delicate appliances (e.g. high power lighting and backlight LEDs), a rise on temperature during emitting, voltage fluctuation, and variation of the LED emitting property from producing will change the steady driving current beyond the settings.

Furthermore, using a current mirror to clamp the driving current by a reference current source is anther constant-current method. As shown in FIG. 6A, two current mirrors 611,612 with same magnification ratio 1:N are integrated together to clamp the driving current I_{LED}=N*I_{ref} by a reference current I_{ref}. Nevertheless, the chip space for two current mirror with 1:N magnification ratio is too large; and the current clamping is not strong enough to manager possible electrical characters change (e.g. effective resister, I-V curve, and chemical and physical characters change) and the followed voltage desire. Too complicate situations are still hard to manager for the traditional constant current drivers.

### SUMMARY OF THE INVENTION

The main objective of this invention is to provide a controllable driver and a driving system with an excellent stability for LEDs. Except a constant-current technology, a particular technology of voltage adjuster in the present invention can auto adjust appliance's driving voltage to fit different requirements for keeping steady driving current even in facing the possible rise on temperature or voltage desire by certain situations.

A driving system according to the present invention can integrate all the said functions successfully but no need of too much chip space especially for light mobile specification.

Further, with the particular technology of voltage adjuster, an additional adjustable-voltage source combined with a user control interface expands the driving system's applicability. Users can select different driving voltages to fit diverse appliance requirements through the control interface. Additionally, an over-temperature and an over-current protection are equipped in the present invention to prevent harms from over-temperature and over-current happenings especially in high power lighting and backlight LEDs.

The present invention will be apparent after reading the detailed description of the preferred embodiments hereinafter in reference to the accompanying drawings.

### BRIEF DESCRIPTION OF THE DRAWINGS

FIG. 1A is a circuit diagram of a driving system according to an embodiment of the present invention (the appliance example is lighting or backlight LED in this figure, but it can be replaced by other appliances).

FIG. 1B is a circuit diagram of an adjustable-voltage source according to an embodiment of the present invention.

FIG. 2A is a traditional constant-voltage driving system (prior art).

FIG. 2B is a traditional constant-current driving system (prior art).

FIG. 3 is a circuit diagram of a current controller according to an embodiment of the present invention (the appliance example is lighting or backlight LED in this figure, but it can be replaced by other appliances).

FIG. 4A is a variation diagram for driving current vs. system temperature during an over-temperature protection in the present invention.

FIG. 4B is a variation diagram for driving current during an over-current protection in the present invention.

FIG. 4C is a variation diagram for driving current during the other over-current protection in the present invention.

FIG. 5 is a schematic diagram of a controllable driver according to an embodiment of the present invention.

FIG. 6A is a circuit diagram of a traditional current mirror (prior art)

FIG. 6B is a circuit diagram of an improved current mirror according to an embodiment of the present invention.

### DETAILED DESCRIPTION OF THE PREFERRED EMBODIMENTS

As an embodiment of the invention, a controllable driver 500 to drive a stead current from high voltage Vₐₚₚ₁ 501 to low voltage Vₐₚₚ₂ 502 in an application 520 comprises: (a) a DC voltage input 510 for DC voltage Vo supply; (b) a 1st field effect transistor (FET) 131 as a voltage adjustor to adjust voltage differential (Vₐₚₚ₁-Vₐₚₚ₂) on the appliance for voltage desire from the steady driving current Iₐₚₚ requirement by changing its drain-to-source voltage differential; (c) a controller 530 to control gate voltage of the 1st FET; and (d) a current controller 140 to clamp the steady driving current as setting. The controller 532 can is operable to detect voltage variation of the appliance and send negative feedback voltage to gate of the 1^{st} FET in order to auto adjust drain-to-source voltage differential of the 1^{st} FET and compensate the said voltage desire for keeping steady driving current. By this negative feedback circuit, the controllable driver in this invention can automatically adjust the proper driving voltage to maintain the steady driving current with excellent stability event in facing large voltage fluctuation, effective resistor variation, hardly objective and subjective situations and so on.

Further, an adjustable-voltage source 110 coupled with this invention is operable to take an external voltage source V_{DD} and supply the said DC voltage Vₒ to the DC voltage input. Furthermore, a controllable interface 160 is operable to take user commands for changing the driving system's setting. With the adjustable-voltage source and the controllable interface, the range of adjustable voltage in this invention becomes more flexible to fit most part of appliance.

Moreover, an over-temperature protection and an over-current protection on circuit 534 of gate voltage of the 1^{st} FET or on the current control are operable to cut-off driving current or set the upper limit of driving current at over-temperature and over-current conditions to remain the controllable driver's normal operation. A temperature sensor 552 and a current monitor 553 are operable to be included in this invention to strengthen the over-temperature and over-current protections.

A driving system to drive a steady current on an appliance mainly comprises six parts: (a) a DC voltage input 510 for DC voltage Vₒ supply; (b) an output for appliance 501 to supply high voltage Vₐₚₚ₁ to the appliance; (c) an input for appliance 502 to supply low voltage Vₐₚₚ₂ to the appliance; (d) a 1^{st} field effect transistor (FET) 131 as a voltage adjuster; (e) a 1^{st} operation amplifier (OpAmp) 132 operable to detect voltage variation of the appliance and send negative feedback voltage to gate of the 1^{st} FET in order to auto adjust drain-to-source voltage differential of the 1^{st} FET and compensate voltage desire for keeping steady driving current; and (f) a current controller 140 to clamp the steady driving current as setting.

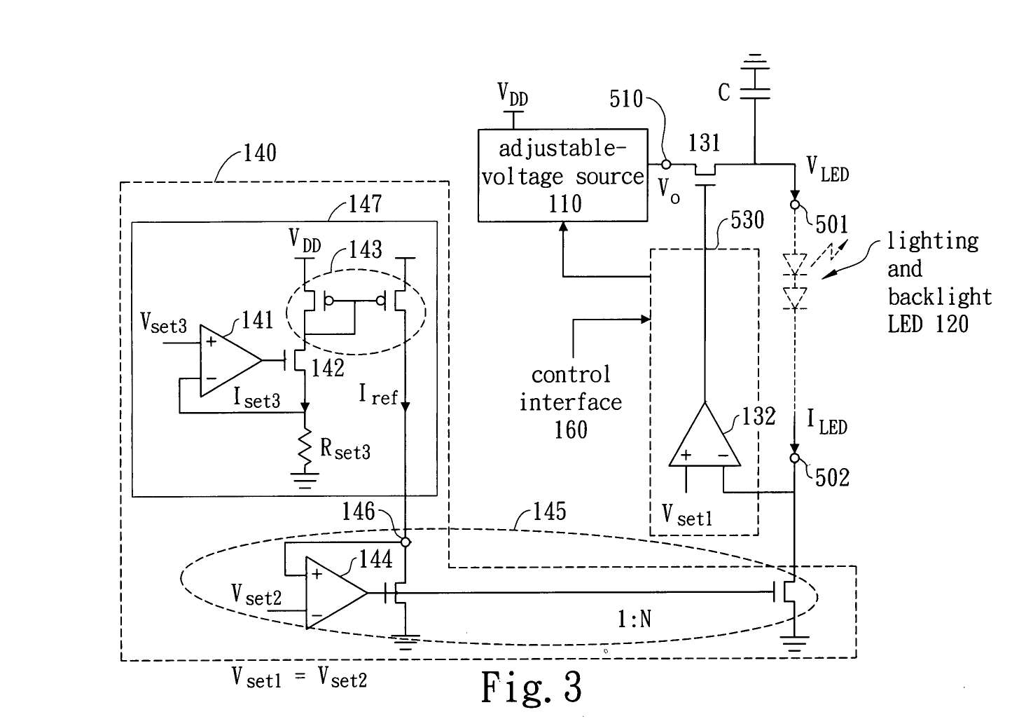

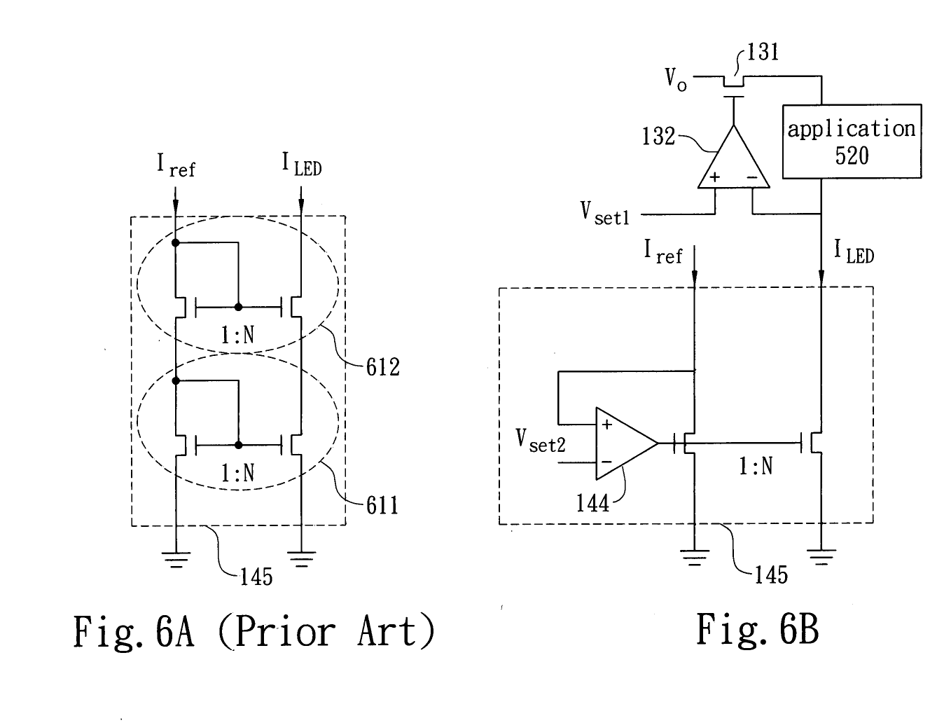

The driving system according to the present invention, wherein the current controller as shown in FIG. 3 (appliance example in this figure is LED) between the appliance and ground takes the driving current from the appliance and also comprises: (a) a reference current source 147 to output a steady reference current I_{ref}; and (b) a current mirror 145 with magnification ratio 1:N to clamp the steady driving current as I_{ref}*N by magnifying the reference current I_{ref}. As shown in FIG. 6B, this current mirror 145 also comprises: a 2^{nd} OpAmp 144 to precisely clamp the magnification ratio 1:N of the current mirror, wherein its positive input and output of the reference current source are on the same voltage; its output and common-gate of the current mirror are on the same voltage; and its negative input and positive input of the 1^{st} OpAmp 132 are on the same voltage (Vₛₑₜ₂=Vₛₑₜ₁) Compared with the bulky traditional current mirror (please see FIG. 6A), this current mirror 145 is smaller. Furthermore, the reference current source also comprises: (a) a 3^{rd} OpAmp 141 wherein its positive input is connected to an energy gap reference voltage, and its negative input and its output are on the same voltage to form a negative feedback circuit; (b) a 2^{nd} FET 142 on negative feedback circuit of the 3^{rd} OpAmp where its gate and output of the 3^{rd} OpAmp are on the same voltage, its source and negative input of the 3^{rd} OpAmp are on the same voltage, and negative input voltage of the 3^{rd} OpAmp is clamped and varied by positive input voltage of the 3^{rd} OpAmp; (c) a resister Rₛₑₜ₃ between negative input of the 3^{rd} OpAmp and ground for current Iₛₑₜ₃ generation through the 2^{nd} FET; and (d) a p channel current mirror 143 to take current Iₛₑₜ₃ of 2^{nd} FET on one side and output the said reference current I_{ref} on the other side.

In order to compensate the said voltage desire on time, the 1^{st} FET has a connection between its source and the output for appliance and a connection between its drain and the DC voltage input in order to adjust voltage differential between the said DC voltage Vₒ and the output for appliance voltage Vₐₚₚ₁; likewise the 1^{st} OpAmp has an input voltage through its negative input from the input for appliance voltage Vₐₚₚ₂ and output the said negative feedback voltage to gate of the 1^{st} FET. Similarly, the 1^{st} FET has a connection between its drain and the input for appliance and a connection between its source and negative input of the 1^{st} OpAmp in order to adjust voltage differential between the input for appliance voltage Vₐₚₚ₂ and negative input voltage of the 1^{st} OpAmp; likewise the 1^{st} OpAmp output the said negative feedback voltage to gate of the 1^{st} FET. In both circuit, they can auto adjust drain-to-source voltage differential of the 1^{st} FET to compensate the said voltage desire for keeping steady driving current. Further, a capacitance between source or drain of the 1^{st} FET and ground is operable to adjust source or drain voltage of the 1^{st} FET.

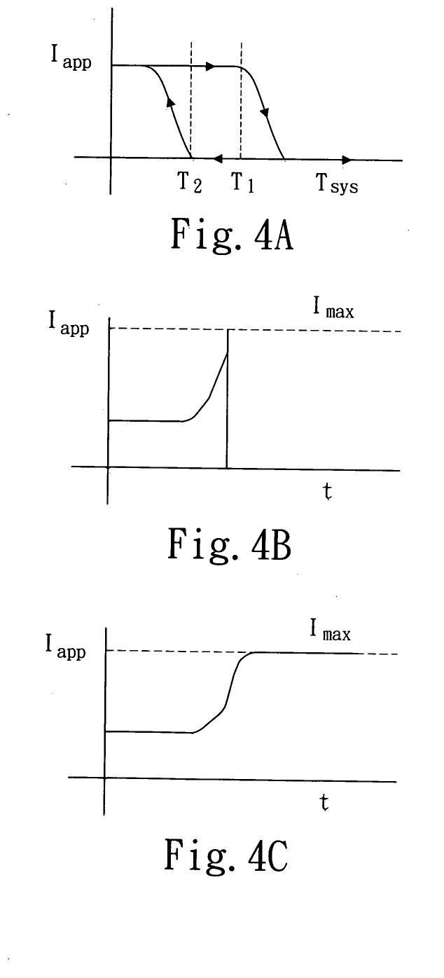

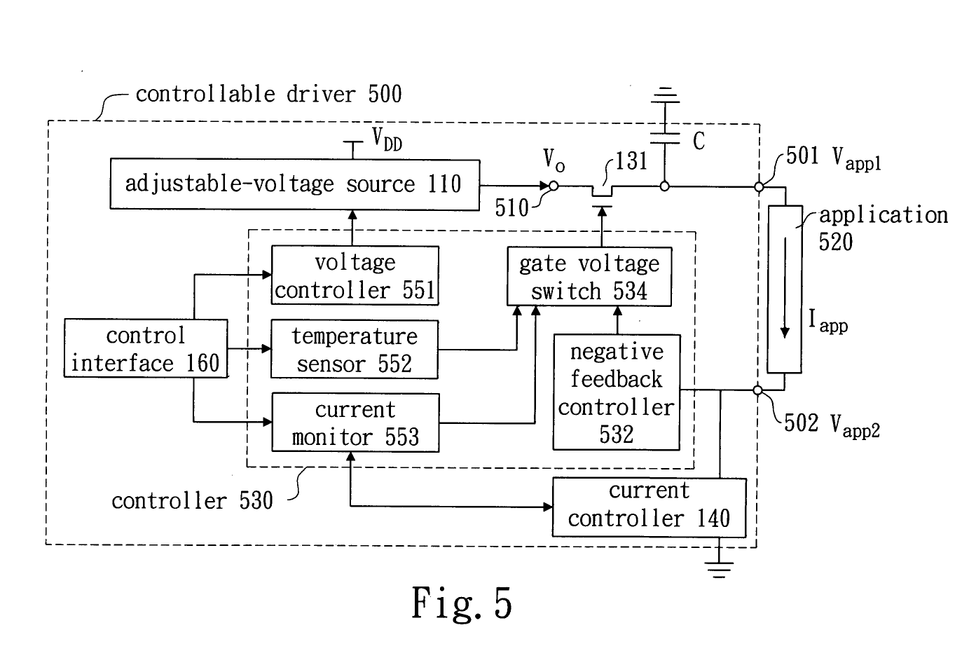

For over-temperature and over-current situations in most high power appliance, the present invention is operable to equip: a temperature sensor to detect system temperature T_{sys}, cut off the driving current as an over-temperature protection when T_{sys}>T₁, and reset for normal operation when system temperature is back to safe operation temperature T_{sys}<T₂ (as arrows in FIG. 4A); and a current monitor to monitor the driving current and cut off the driving current (as shown in FIG. 4B) or keep the driving current on an upper limit (as shown in FIG. 4C) as an over-current protection to prevent terrible harms for appliances. The over-temperature and over-current protections can be appendixed on gate voltage circuit 534 of the 1^{st} FET or on output circuit of the 2^{nd} OpAmp 144 but no need of an extra circuit for them.

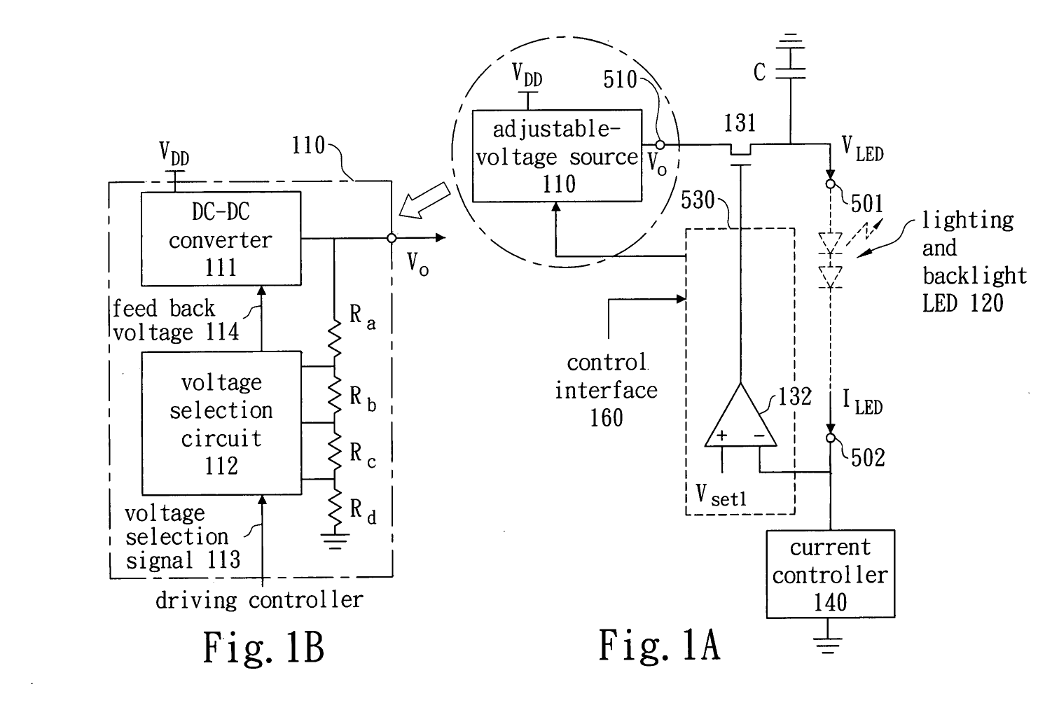

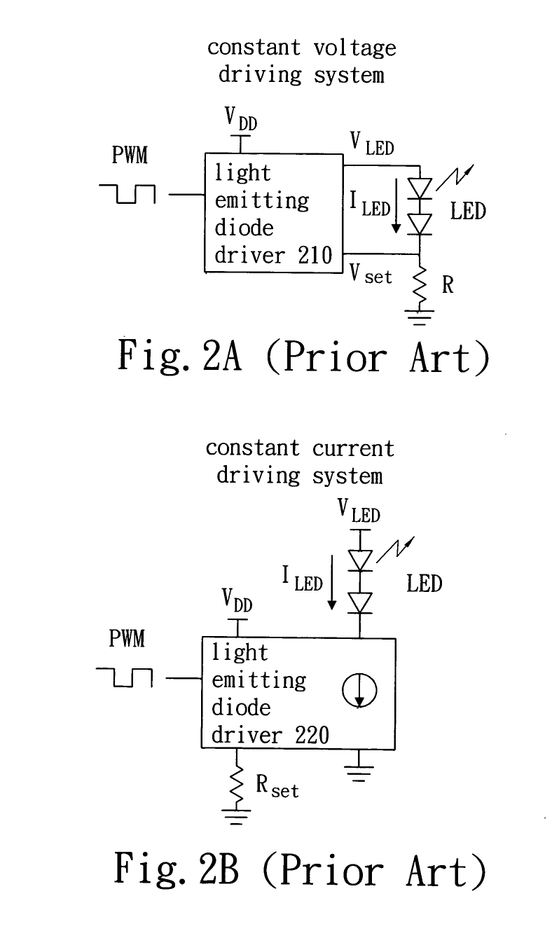

The driving system according to the present invention can be associated with an adjustable-voltage source 110 comprising: a DC-DC converter 111 or a voltage regulator or an AC-DC converter to rise/lower and rectify an external voltage source V_{DD} for output of the DC voltage Vₒ as shown in FIG. 1B. Further, combining a voltage selection circuit 112 or an analog switch and digital control circuit can help the adjustable-voltage source to change the value of Vₒ more functionally by taking voltage selection signal 113 and switching a proper voltage circuit for feedback voltage 114 on circuit between the said external voltage source V_{DD} and the DC voltage Vₒ. Furthermore, a controllable interface 160 is operable to take user commands for changing the voltage circuit in the adjustable-voltage source through a voltage controller 551. The DC-DC converter 111 or the voltage regulator or the AC-DC converter is operable to have low drop-out function in order to avoid voltage dissipation from low input voltage. Moreover, a plurality of charge pumps can also be comprised to rise or lower voltage. With the above operable circuits, the range of adjustable voltage in the present invention becomes more flexible to fit most part of appliance.

Accordingly, as disclosed by the above description and accompanying drawings, the present invention surely can accomplish its objective to provide a controllable driver and a driving system with excellent stability for LEDs, and may be put into industrial use especially for mass product.

It should be understood that various modifications and variations could be made from the teaching disclosed above by the persons familiar in the art, without departing the spirit of the present invention.

What is claimed is:

1. A light emitting diode (LED) controllable driver to drive a steady current from high voltage Vₐₚₚ₁ to low voltage Vₐₚₚ₂ in an appliance comprises:
(a) a DC voltage input for DC voltage Vₒ supply;
(b) a 1^{st} field effect transistor (FET) as a voltage adjustor to adjust voltage differential (Vₐₚₚ₁-Vₐₚₚ₂) on the appliance for voltage desire from the steady driving current Iₐₚₚ requirement by changing its drain-to-source voltage differential;
(c) a controller to control gate voltage of the 1^{st} FET; and
(d) a current controller to clamp the steady driving current as setting.

2. A LED controllable driver according to claim 1, wherein the controller can is operable to detect voltage variation of the appliance and send negative feedback voltage to gate of the 1^{st} FET in order to auto adjust drain-to-source voltage differential of the 1^{st} FET and compensate the said voltage desire for keeping steady driving current.

3. A LED controllable driver according to claim 1 also comprises: an adjustable-voltage source to output an adjustable DC voltage Vₒ to the DC voltage input from an external voltage source V_{DD}.

4. A LED controllable driver according to claim 1 also comprises: a control interface to take user commands and output signal to the controller for command action.

5. A LED controllable driver according to claim 1 also comprises: an over-temperature protection to cut off the said driving current Iₐₚₚ by controlling gate voltage of the 1^{st} FET at over temperature condition.

6. A LED controllable driver according to claim 1 also comprises: an over-current protection to cut off the said driving current Iₐₚₚ by controlling gate voltage of the 1^{st} FET at over current condition.

7. A LED controllable driver according to claim 1 also comprises: an over-temperature protection to cut off the said driving current Iₐₚₚ by controlling the current controller at over temperature condition.

8. A LED controllable driver according to claim 1 also comprises: an over-current protection to cut off the said driving current Iₐₚₚ by controlling the current controller at over current condition.

9. A LED controllable driver according to claim 1 also comprises: an over-current protection to set an upper limit of the said driving current Iₐₚₚ by controlling the current controller at over current condition.

10. A LED controllable driver according to claim 3 also comprises: a voltage controller to change value of the said adjustable DC voltage Vₒ outputted from the adjustable-voltage source.

11. A LED controllable driver according to claim 1 also comprises: a temperature sensor to detect system temperature T_{sys} and execute an over-temperature protection at over temperature condition.

12. A LED controllable driver according to claim 1 also comprises: a current monitor to monitor the said driving current and execute an over-current protection at over current condition.

13. A LED controllable driver according to claim 1 also comprises: a capacitance between source of the 1^{st} FET and ground to adjust source voltage of the 1^{st} FET.

14. A LED controllable driver according to claim 1 also comprises: a capacitance between drain of the 1^{st} FET and ground to adjust drain voltage of the 1^{st} FET.

15. A driving system to drive a steady current on an appliance comprises:
(a) a DC voltage input for DC voltage Vₒ supply;
(b) an output for appliance to supply high voltage Vₐₚₚ₁ to the appliance;
(c) an input for appliance to supply low voltage Vₐₚₚ₂ to the appliance;
(d) a 1^{st} field effect transistor (FET) as a voltage adjuster;
(e) a 1^{st} operation amplifier (OpAmp) operable to detect voltage variation of the appliance and send negative feedback voltage to gate of the 1^{st} FET in order to auto adjust drain-to-source voltage differential of the 1^{st} FET and compensate voltage desire for keeping steady driving current; and
(f) a current controller to clamp the steady driving current as setting.

16. A driving system according to claim 15, wherein the current controller between the appliance and ground takes the driving current from the appliance and also comprises:
(a) a reference current source to output a steady reference current I_{ref}; and
(b) a current mirror with magnification ratio 1:N to clamp the steady driving current as I_{ref}*N by magnifying the reference current I_{ref}.

17. A driving system according to claim 16 also comprises: a 2^{nd} OpAmp to precisely clamp the magnification ratio 1:N of the current mirror, wherein its positive input and output of the reference current source are on the same voltage; its output and common-gate of the current mirror are on the same voltage; and its negative input and positive input of the 1^{st} OpAmp are on the same voltage (Vₛₑₜ₂=Vₛₑₜ₁).

18. A driving system according to claim 16, wherein the reference current source also comprises:
(a) a 3^{rd} OpAmp wherein its positive input is connected to an energy gap reference voltage, and its negative input and its output are on the same voltage to form a negative feedback circuit;
(b) a 2^{nd} FET on negative feedback circuit of the 3^{rd} OpAmp where its gate and output of the 3^{rd} OpAmp are on the same voltage, its source and negative input of the 3^{rd} OpAmp are on the same voltage, and negative input voltage of the 3^{rd} OpAmp is clamped and varied by positive input voltage of the 3^{rd} OpAmp;
(c) a resister Rₛₑₜ₃ between negative input of the 3^{rd} OpAmp and ground for current Iₛₑₜ₃ generation through the 2^{nd} FET; and
(d) a p channel current mirror to take current Iₛₑₜ₃ of 2^{nd} FET on one side and output the said reference current I_{ref} on the other side.

19. A driving system according to claim 15, wherein the 1^{st} FET is a metal-oxide-semiconductor field effect transistor (MOSFET).

20. A driving system according to claim 18, wherein the 2^{nd} FET is a metal-oxide-semiconductor field effect transistor (MOSFET).

21. A driving system according to claim 15 also comprises: an adjustable-voltage source to take an external voltage source V_{DD} and supply the said DC voltage Vₒ to the DC voltage input.

22. A driving system according to claim 15 also comprises: a controllable interface to take user commands for changing the driving system's setting.

23. A driving system according to claim 15, wherein the 1^{st} FET has a connection between its source and the output for appliance and a connection between its drain and the DC voltage input in order to adjust voltage differential between the said DC voltage Vₒ and the output for appliance voltage Vₐₚₚ₁; and the 1^{st} OpAmp has an input voltage through its negative input from the input for appliance voltage Vₐₚₚ₂ and output the said negative feedback voltage to gate of the 1^{st} FET in order to auto adjust drain-to-source voltage differential of the 1^{st} FET and compensate the said voltage desire for keeping steady driving current.

24. A driving system according to claim 15, wherein the 1^{st} FET has a connection between its drain and the input for appliance and a connection between its source and negative input of the 1^{st} OpAmp in order to adjust voltage differential between the input for appliance voltage Vₐₚₚ₂ and negative input voltage of the 1^{st} OpAmp; and the 1^{st} OpAmp output the said negative feedback voltage to gate of the 1^{st} FET in order to auto adjust drain-to-source voltage differential of the 1^{st} FET and compensate the said voltage desire for keeping steady driving current.

25. A driving system according to claim 15 also comprises: a capacitance between source of the 1^{st} FET and ground to adjust source voltage of the 1^{st} FET.

26. A driving system according to claim 15 also comprises: a capacitance between drain of the 1^{st} FET and ground to adjust drain voltage of the 1^{st} FET.

27. A driving system according to claim 15 also comprises: an over-temperature protection to cut off driving current by controlling gate voltage of the 1^{st} FET when system temperature T_{sys} is over temperature.

28. A driving system according to claim 15 also comprises: an over-current protection to cut off driving current by controlling gate voltage of the 1^{st} FET at over current condition.

29. A driving system according to claim 15 also comprises: an over-temperature protection to cut off driving current by controlling common-gate voltage of the 1:N current mirror of the current controller when system temperature T_{sys} is over temperature.

30. A driving system according to claim 15 also comprises: an over-current protection to cut off driving current by controlling common-gate voltage of the 1:N current mirror of the current controller at over current condition.

31. A driving system according to claim 15 also comprises: an over-current protection to set an upper limit of driving current by controlling the 1:N current mirror of the current controller at over current condition.

32. A driving system according to claim 21 also comprises: a voltage controller to change value of the said adjustable DC voltage Vₒ outputted from the adjustable-voltage source.

33. A driving system according to claim 15 also comprises: a temperature sensor to detect system temperature T_{sys}, execute an over-temperature protection when T_{sys}>T₁, and reset for normal operation when system temperature is back to safe operation temperature T_{sys}<T₂.

34. A driving system according to claim 15 also comprises: a current monitor to monitor the said driving current and execute an over-current protection at over current condition.

35. A driving system according to claim 21, wherein the adjustable-voltage source also comprises: a voltage regulator to rise/lower and rectify the said external voltage source V_{DD} for output of the DC voltage Vₒ.

36. A driving system according to claim 21, wherein the adjustable-voltage source also comprises: a DC-DC converter to rise/lower and rectify the said external voltage source V_{DD} for output of the DC voltage Vₒ.

37. A driving system according to claim 21, wherein the adjustable-voltage source also comprises: an AC-DC converter to rise/lower and rectify the said external voltage source V_{DD} for output of the DC voltage Vₒ.

38. A driving system according to claim 21, wherein the adjustable-voltage source also comprises: a plurality of charge pumps to rise/lower voltage.

39. A driving system according to claim 21, wherein the adjustable-voltage source also comprises: a voltage selection circuit to take voltage signal, to switch a proper voltage circuit for feedback voltage on circuit between the said external voltage source V_{DD} and the DC voltage Vₒ, and finally to change the value of Vₒ.

40. A driving system according to claim 21, wherein the adjustable-voltage source also comprises: an analog switch and digital control circuit to take voltage change command, to switch a proper voltage circuit for feedback voltage on circuit between the said external voltage source V_{DD} and the DC voltage Vₒ, and finally to change the value of Vₒ.

41. A driving system according to claim 32, wherein the voltage controller is operable to use pulse width modulation (PWM) to control the appliance on-and-off and in which form.

42. A driving system according to claim 15 is operable to drive lighting light emitting diode (LED).

43. A driving system according to claim 15 is operable to drive backlight LED.

44. A driving system according to claim 21, wherein the adjustable-voltage source is operable to have low drop-out function in order to avoid voltage dissipation from low input voltage.
